(19) United States
(12) Patent Application Publication
(10) Pub. No.: US 2013/0228535 A1
(43) Pub. Date: Sep. 5, 2013

(54) BICYCLE RACK

(71) Applicants: ERIK DAVID WOOD, Chicago, IL (US); PAUL RAYMOND GRAHAM, Chicago, IL (US)

(72) Inventors: ERIK DAVID WOOD, Chicago, IL (US); PAUL RAYMOND GRAHAM, Chicago, IL (US)

(21) Appl. No.: 13/783,203

(22) Filed: Mar. 1, 2013

Related U.S. Application Data
(60) Provisional application No. 61/606,391, filed on Mar. 3, 2012.

(51) Int. Cl. B62H 3/00; B62H 5/00

(52) U.S. Cl. CPC B62H 3/00; B62H 5/005
USPC 211/5; 211/17

(57) ABSTRACT

A bicycle parking system that includes a compartment for storing items. The compartment for storing items may have an opening for receiving the items. The compartment may be secured, and the items enclosed therein, by parking and securing a bicycle into a bicycle receiving space.

### RELATED APPLICATIONS

The present patent document claims the benefit of the filing date under 35 U.S.C. §119(e) of Provisional U.S. Patent Application Ser. No. 61/606,391, filed Mar. 3, 2012, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Bicycle transportation has been popular for over 200 hundred years. Bicycles are used for transportation in many environments, including but not limited to urban and rural areas for practical transportation and also in urban, rural and recreational areas for entertainment, healthy exercise, and competitive sport.

Bicycles, bicycle parts, and accessories are subject to theft. For example, entire bicycles, bicycle frames, bicycle seats, bicycle tires, and other components and accessories of bicycles. To prevent theft, several variations of bicycle locks have been developed. These range from U-shaped metal locks to chains, and cables, among others.

Bicycle locks are typically used in conjunction with bicycle parking systems to secure the various vulnerable bicycle components in an arrangement that deters theft. However, properly securing a bicycle using traditional bicycle parking systems is a continuous challenge. Often, bicycle owners simply remove and carry with the them various items vulnerable to theft, such as their helmet, their seat, and sometimes even wheels.

### BRIEF SUMMARY

A bicycle parking system has a frame defining a space for receiving at least one bicycle. A compartment is integrated with the frame. The compartment is dimensioned to hold bicycle accessories, for example, but not limited to bicycle helmets, bicycle seats, bicycle gloves, or otherwise. The compartment includes an opening for receiving such accessories and items. The compartment and the bicycle-receiving frame are oriented such that when a bicycle is received within the frame, the compartment opening is blocked by a component of the bicycle.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

Figures depict various variations of the claimed system.

FIG. 1 illustrates a bicycle rack assembled with bicycles.

FIG. 2 illustrates a second perspective view of a rack.

FIG. 3 illustrates a third view of a rack illustrating use.

FIG. 4 illustrates a top view of a rack.

FIG. 5 illustrates a cut out view of a rack assembled with a bike.

FIG. 6 illustrates a second variation of the system.

FIG. 7 illustrates a close up of a portion of the system.

FIG. 8 illustrates a third variation of the system.

FIG. 9 illustrates a bicycle rack in an environment assembled with a bike.

### DETAILED DESCRIPTION OF THE DRAWINGS

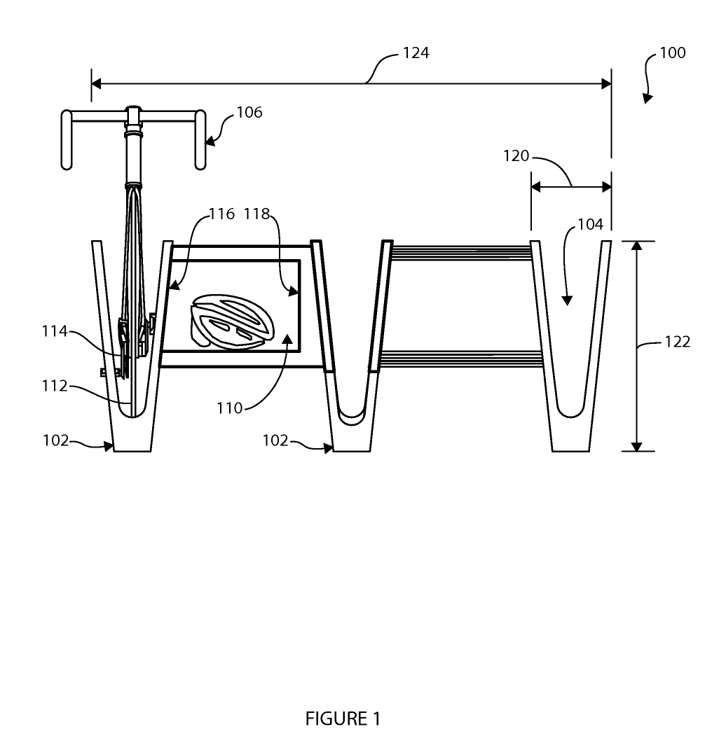

FIG. 1 illustrates a first variation of a bicycle parking system 100. The bicycle parking system includes a frame 102 defining an opening 104 for receiving a bicycle 106 therein. The bicycle parking system 100 also includes a compartment 110. The opening 104 of the frame 102 may be wedge shaped. The wedge shape of the opening 104 may receive a wheel 112 and/or wheel 112 and wheel 112 and front forks 114. The installation of the wheel 112 and or wheel 112 and front forks 114 into the opening 104 may stabilize the bicycle 106. The opening 104 may be dimensioned such that the opening 104 approximates the assembly of a wheel 112 with the front forks 114 of a bicycle 106 frame.

The compartment 110 may have an opened end 116 and a closed end 118. The compartment 110 may be associated with the frame 102 such that the open end 116 opens into the opening 104 for receiving a bicycle. The compartment 110 may be dimensioned to receive items therein, such as a hat or helmet, a bicycle seat, a back pack, a purse, a lunch bag, a small pet, or other items. While a helmet is illustrated in FIG. 1, the compartment is not limited to the storage of helmets. The compartment 110 and the frames 102 may be arranged such that the open end 116 of the compartment 110 is securely obstructed by the entry into the opening 104 of a bicycle 106.

The exemplary system 100 may include a series of compartments 110 and frames 102 such that it is capable of retaining multiple bicycles 106 (e.g., as shown in FIG. 1). Additionally or alternatively, the exemplary system 100 may be dimensioned such that the compartments 110 may serve as seating for pedestrians or bikers. The variation is dimensioned to accommodate a bike 106. The following example provides exemplary dimensions for one variation, but these dimensions are merely for purposes of illustration and are not limiting.

Exemplary dimensions for the present variation may include but are not limited to—a dimension 122 representing the height of the frame 102 from the ground and which may be approximately two feet. Dimension 120 of the opening 104 for receiving a bicycle may be approximately 9″. These dimensions are merely illustrative of dimensions that might be appropriate for one style and size of bicycle and are not meant to be limiting. An exemplary length 124 of the system according to one non-limiting variation of this system may be approximately 4′-6′. This dimension would of course be modified by changing the size of the compartments 110, the dimensions of the opening 104 and/or adding or subtracting a number of units of frames 102 and/or compartments 110.

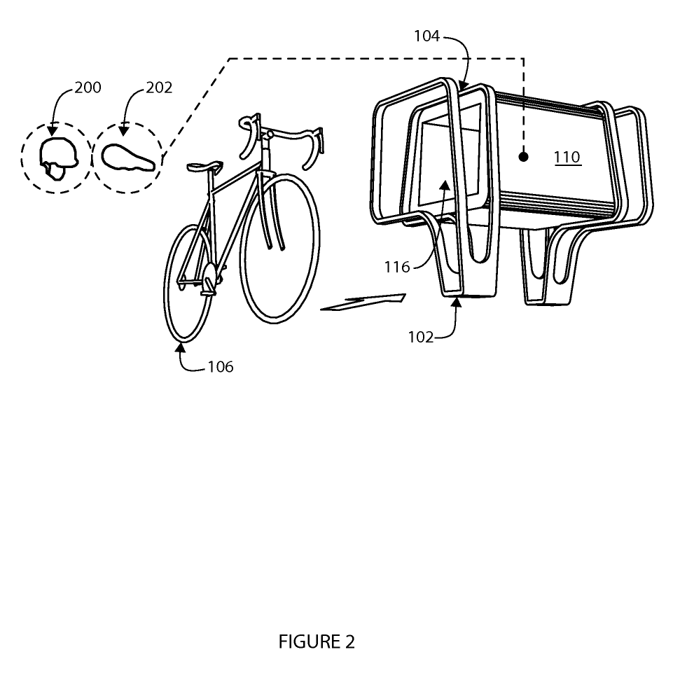

FIG. 2 illustrates a second variation and view of this system. In this figure, the method of using the compartment 110, the bike 106 and the frame 102 to secure items such as but not limited to helmets 200 and bike seats 202. The items such as but not limited to helmets 200 and bike seats 202 may be inserted into the compartment 110 through the open end 116 of the compartment 110 which may be accessible through the opening 104 in the frame 102. After the items are deposited into the compartment 110 the bicycle 106 may be inserted into the opening 104 in the frame 102 thereby securing the items into the compartment 110 by blocking open end 116 of the compartment 110.

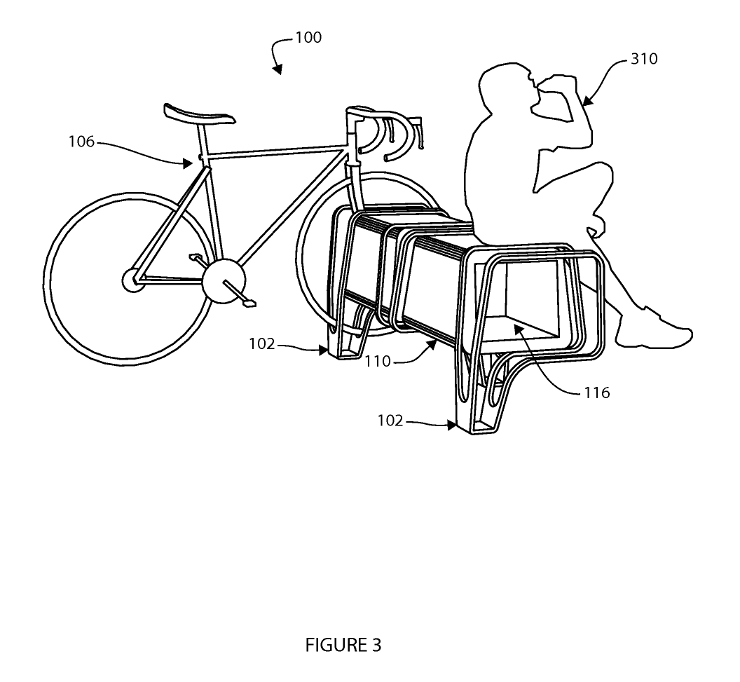

FIG. 3 is an additional view of a variation of the system illustrating a possible use of the system 100. In this figure, an individual 310 uses the compartment 110 as a seating location. A bicycle 106 is installed into a frame 102 securing the open end 116 of a compartment 110. It also illustrates that, where the system includes multiple frames 102 and compartments 110, the orientation of the frames 102 may be alternated such that the bicycles held therein are held in a staggered formation.

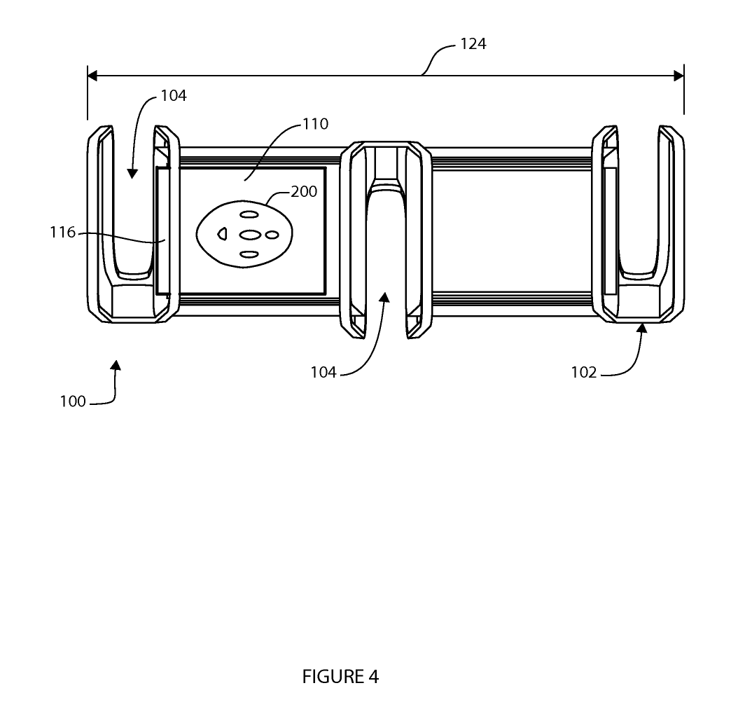

FIG. 4 illustrates a top view of one variation of a bicycle parking system 100. This view illustrates again how the bicycle receiving frames 102 may have alternating orientations. Additionally or alternatively, the bicycle receiving frames may have identical orientations. From a top view, the figure illustrates the inside of a compartment 110 showing a item, which may be a helmet 200, stored therein.

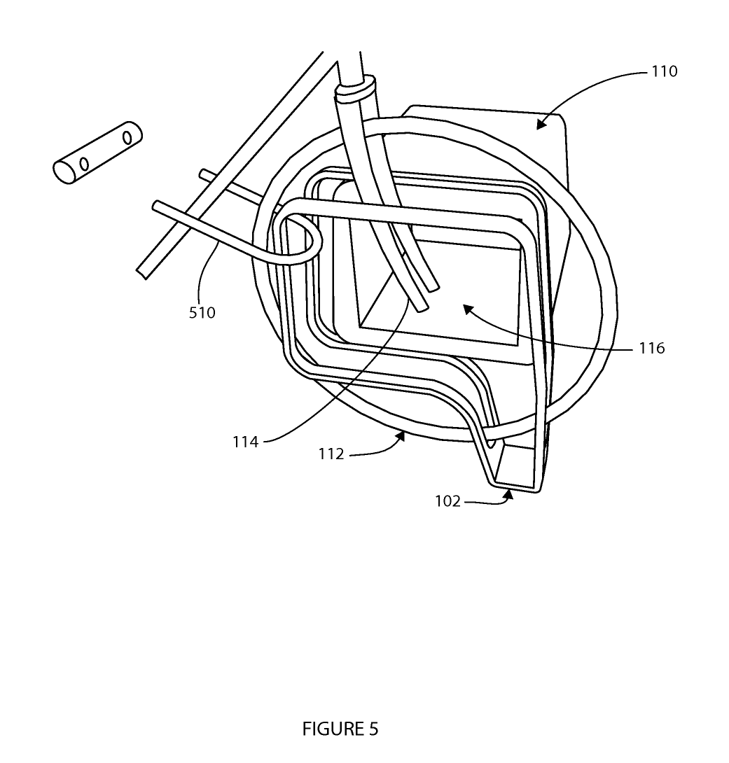

FIG. 5 is a cut out view of a variation of a bicycle parking system 100. This view illustrates how when a bicycle part, such as a bicycle tire 112 is received within the opening 104 of a frame 102 an opening 116 of a compartment 110 may be blocked such that any materials that are deposited in the compartment 110 may be secured from retrieval by thieves. FIG. 5 also illustrates the association of a bicycle lock 510, which in this case is a U-lock. The frame 102 is adapted to receive the bicycle lock 510. The frame 102 may have a means for receiving a locking device such as a U-lock, chain, cord, or otherwise.

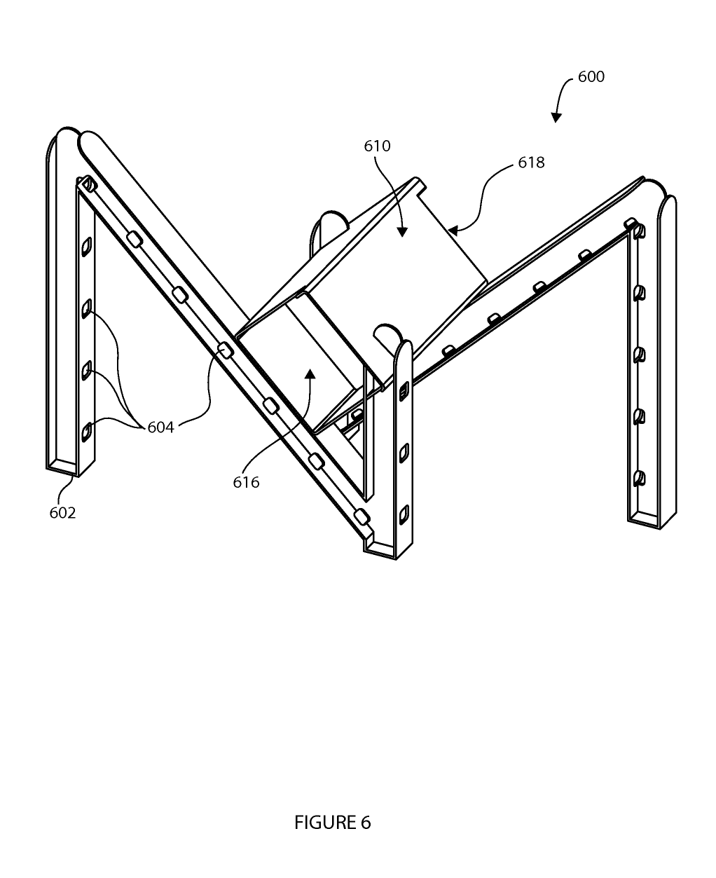

FIG. 6 illustrates a second variation of a bicycle parking system.

The bicycle parking system includes a frame 602 defining to which a bicycle may be secured. The frame 602 includes openings 604 which may receive one of various types of bike locks known. The bicycle parking system 600 also includes a compartment 610.

The compartment 610 may have an opened end 616 and a closed end 618. The compartment 610 may be associated with the frame 602 such that the open end 616 opens into space for receiving a bicycle. The compartment 610 may be dimensioned to receive items therein, such as a hat or helmet, a bicycle seat, a back pack, a purse, a lunch bag, a small plant, or other items. The compartment 610 and the frames 602 may be arranged such that the open end 616 of the compartment 610 is securely obstructed by the securing of a bicycle to the frame 602.

In all variations, the compartment 110, 610, etc., may me made of materials such as steel, composite, rubber, plastic, or any other material, for example a material that resists easy penetration by thieves. The compartment 110, 610, etc. may include slots for draining out, e.g. rainwater or spills, or may be solid.

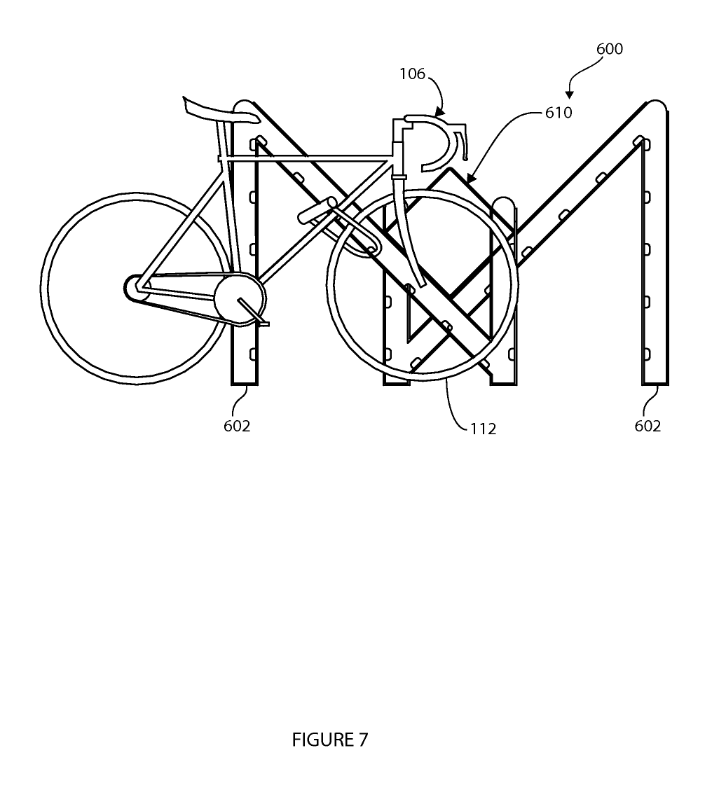

FIG. 7 demonstrates how an opening FIG. 6, 616 of the compartment 610 may be secured when a bicycle 106 is secured to the bicycle parking system 600.

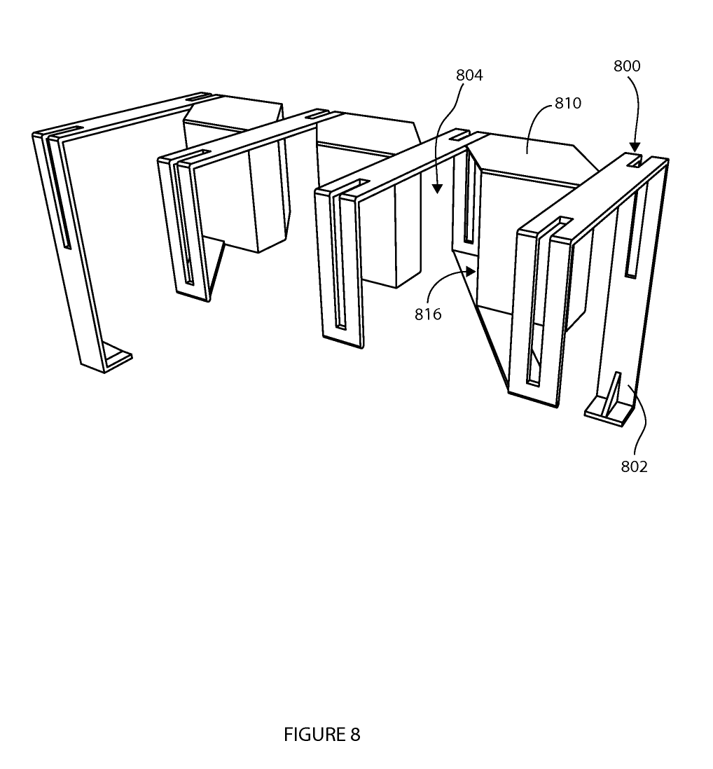

FIG. 8 illustrates a third variation of a bicycle parking system 800. In this example there is a frame 802 and a compartment 810, the compartment 810 having an opening 816 for receiving articles such as helmets, bags, bike seats, tea kettles, etc. This variation of the system also illustrates how upon receiving a bicycle into a bicycle receiving slot 804 the compartment opening 816 may be closed, securing the objects therein.

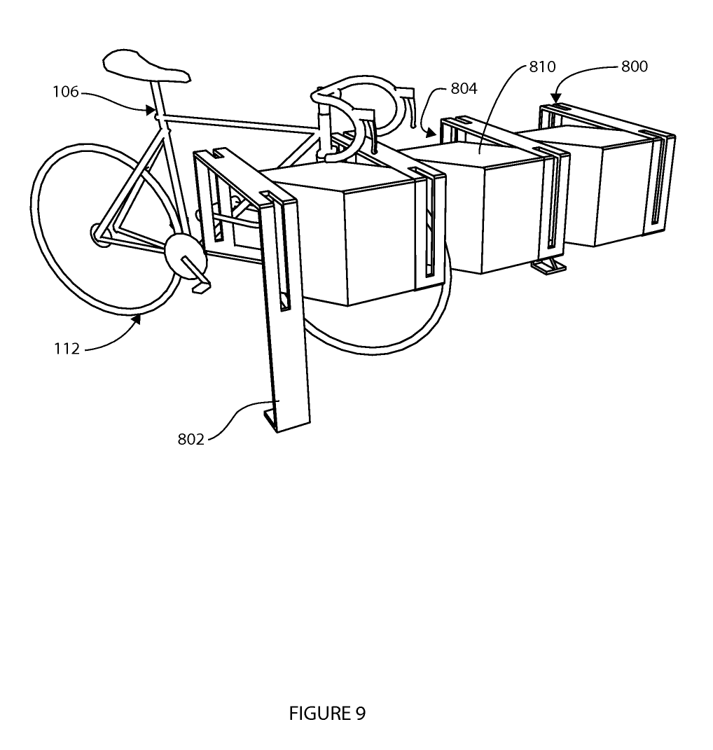

FIG. 9 is a simple illustration of a bike 106 assembled with the system 800.

The disclosed bicycle parking system may have increased functionality over existing systems. The present disclosure demonstrates a system that improves both the flexibility of the parking system, adds storage capacity in a manner that utilizes the function of the system. And in some variations adds seating. In some variations, the system allows the user to store items such as but not limited to helmets, seats, and other items, therefore freeing their hands so that they do not have to carry them around.

In some variations, the system employs what may be referred to as “funneling entry” which may refer to the dimensioning of the bicycle receiving spaces which may guide the user to properly align the bike with the system. Each variation may include various means for securing a bicycle to the system, including cut outs, dimensioning of frames to accommodate locking systems, and otherwise.

Each variation demonstrated herein may be stacked, duplicated, multiplied, or otherwise added on to or decreased in size to accommodate fewer or more bicycles. While most variations are shown attached to the ground, they may also be attached to a vertical surface, such as a wall.

In some variations of the system, the system may act as bicycle storage as well as functional seating and/or storage. For example, the user merely puts its items into the storage compartments and then inserts and locks their bike to secure the belongings therein. The size of variations involving benches may be adjusted to increase or decrease maximum seating space depending on the needs of the particular area in which the system is employed.

In one variation, the frame may be built out of for example but not limited to ½″ formed steel pate rails. The frame may be, for example but not limited to, anchor bolted to the ground. The frame in any variation may be powder coated or painted to eliminate rust. The compartments may be fabricated out of, for example but not limited to, structural materials such as metal sheet or metal plating (e.g., stainless, aluminum, steel). The outside layer of the compartment may be perforated for breathability. Alternating the upright components of the system may increase rigidity and strength.

In other variations may be fabricated from, for example but not limited to, ½″ plate steel, CORTEN Steel, or other materials. Any system may be power coated or painted. Each system may have multiple locking points, as illustrated in the drawings.

The method of using the system may include at least the steps of placing an item into the compartment, sliding a portion of a bicycle, such as the wheel, through or into a receiving slot, and using various means to lock the bicycle to the system.

While various embodiments of the invention have been described, it will be apparent to those of ordinary skill in the art that many more embodiments and implementations are possible that are within the scope of the invention.

1. A bicycle parking system comprising
a frame;
the frame defining a space for receiving a bicycle,
a compartment integrated with the frame;
the compartment having an opening for receiving items;
the compartment oriented with the frame such that when the frame receives a bicycle; the opening to the compartment is blocked.

2. A bicycle parking system comprising:
a frame defining a space for receiving a bicycle;
a compartment adapted for receiving items;
the frame and compartment oriented such that the opening to the compartment is secured when a bicycle is received within the bicycle receiving frame.

3. A method for using a parking system comprising the steps of:
placing items into a compartment
sliding a bicycle part into a receiving slot
securing the bicycle to the system.
